(19) United States
(12) Patent Application Publication
(10) Pub. No.: US 2014/0239570 A1
(43) Pub. Date: Aug. 28, 2014

(54) OPTICAL LENS CLAMPING APPARATUS

(71) Applicant: HON HAI PRECISION INDUSTRY CO., LTD., New Taipei (TW)

(72) Inventor: CHIH-HAO CHU, New Taipei (TW)

(73) Assignee: HON HAI PRECISION INDUSTRY CO., LTD., New Taipei (TW)

(21) Appl. No.: 14/022,244

(22) Filed: Sep. 10, 2013

(30) Foreign Application Priority Data
Feb. 27, 2013 (TW) 102107128

(51) Int. Cl. B23Q 3/06

(52) U.S. Cl. CPC B23Q 3/062
USPC 269/165

(57) ABSTRACT

An optical lens clamping apparatus for clamping an optical lens is provided. The clamping apparatus includes a base, a clamping portion positioned on the base, and an engaging block. The clamping portion includes two clamping arms rotatably connected to the base. Each clamping portion includes a clamping section and an adjusting section connected to the clamping section. The adjusting section and the clamping section form an obtuse angle therebetween. The clamping sections of the clamping arms are positioned substantially parallel to each other and are spaced a predetermined distance from each other. The adjusting sections of the clamping arms form a predetermined angle therebetween. The engaging block moves relative to the clamping portion to adjust an angle between the adjusting sections, so that the clamping sections clamp or release the optical lens.

### BACKGROUND

1. Technical Field

The present disclosure relates to clamping apparatuses, and particularly to a clamping apparatus for clamping an optical lenses.

2. Description of Related Art

In an assembling process and/or a manufacturing process of optical lenses, the optical lenses are clamped by a clamping apparatus. A force applied on an optical lens by the clamping apparatus should be suitable to firmly clamp the optical lens while avoiding damage to the optical lens. However, it is inconvenient to adjust the force to a suitable level according to different sizes of the optical lenses.

Therefore, what is needed is an optical lens clamping apparatus addressing the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is an assembled, isometric view of an optical lens clamping apparatus, according to one embodiment.

FIG. 2 is an exploded view of the optical lens clamping apparatus of FIG. 1.

FIG. 3 is similar to FIG. 1, but shows the optical lens clamping apparatus from another angle.

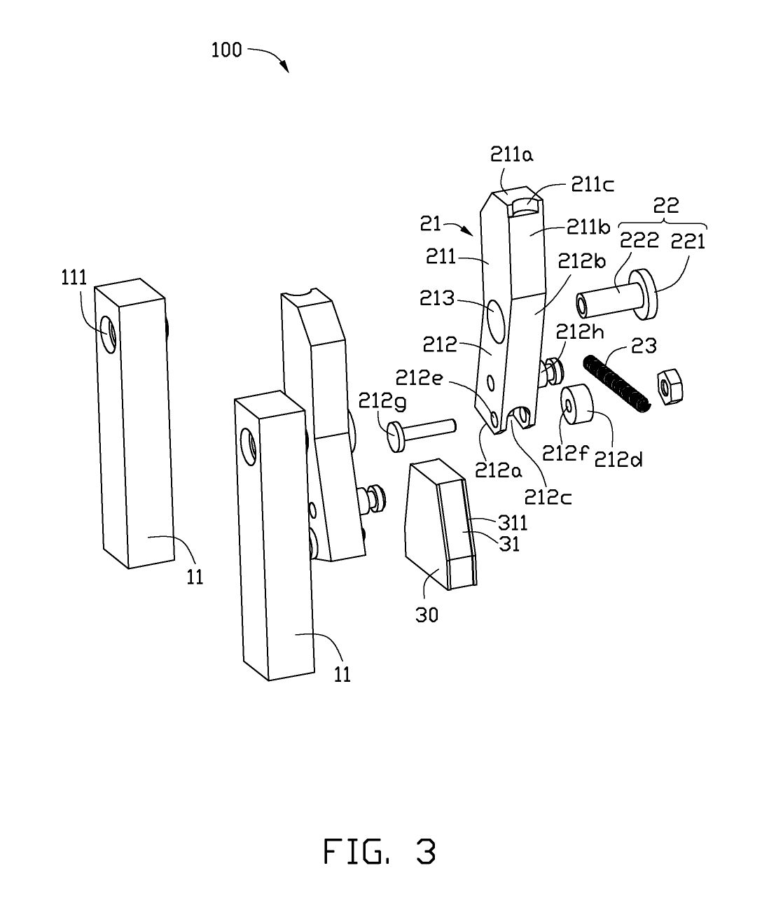

### DETAILED DESCRIPTION

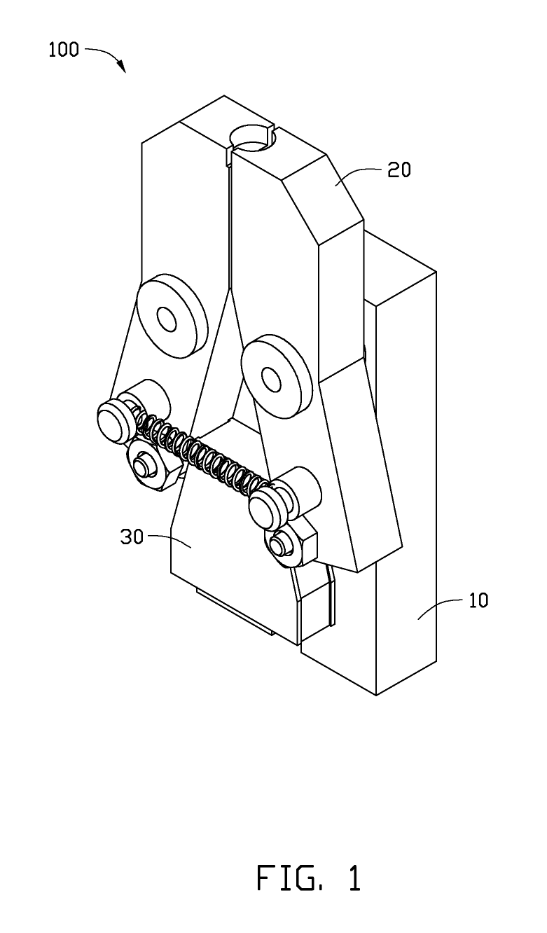

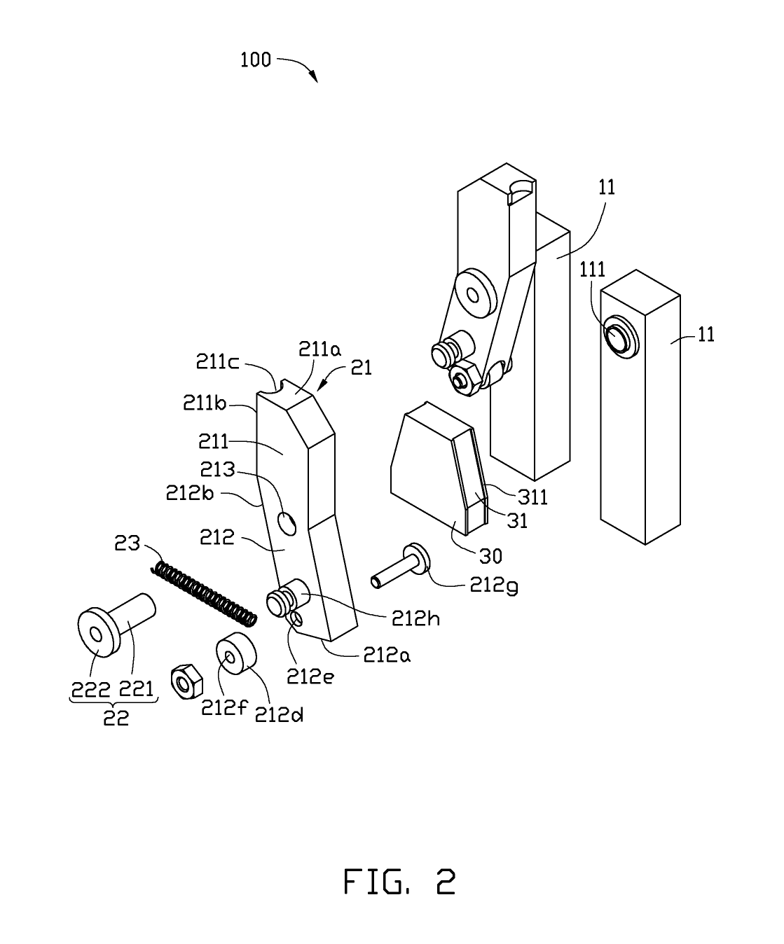

FIGS. 1-2 show one embodiment of an optical lens clamping apparatus 100. The optical lens clamping apparatus 100 includes a base 10, a clamping portion 20 positioned on the base 10, and an engaging block 30.

The base 10 includes two positioning blocks 11 spaced from each other. Each positioning block 11 defines a positioning hole 111. The positioning holes 111 are configured for positioning the clamping portion 20 on the base 10. A distance between the positioning holes 111 is adjusted by changing a distance between the positioning blocks 11. In use, the positioning blocks 11 are fixed on a worktable (not shown) or a robotic arm (not shown). In other embodiments, the positioning blocks 11 can be integrally formed with each other.

The clamping portion 20 includes two clamping arms 21 axially symmetric with each other. Each clamping arm 21 includes a clamping section 211 and an adjusting section 212 connected to the clamping section 211. An obtuse angle is formed between the clamping section 211 and the adjusting section 212.

The clamping section 211 includes a first end surface 211a away from the adjusting section 212 and a first inner side surface 211b facing the clamping section 211 of the other clamping arm 21. The clamping section 211 defines a recess 211c in the first end surface 211a. The recess 211c extends into the first inner surface 211b of the clamping section 211. A shape of the recess 211c can be changed according to a shape of an optical lens (not shown) to be clamped. In this embodiment, the recess 211c is substantially semi-circular.

The adjusting section 212 includes a second end surface 212a away from the clamping section 211 and a second inner side surface 212b facing the adjusting section 212 of the other clamping arm 21. The adjusting section 212 defines a groove 212c in the second inner side surface 212b. In this embodiment, the groove 212c passes through the second end surface 212a. The adjusting section 212 includes a wheel 212d rotatably received in the groove 212c. A portion of a round peripheral surface of the wheel 212d protrudes out of the second inner side surface 212b. In this embodiment, the adjusting section 212 defines a fixing hole 212e passing through two opposite sides of the adjusting section 212. The fixing hole 212e is positioned adjacent to the second end surface 212a and communicates with the groove 212c. The wheel 212d defines a central through hole 212f. The through hole 212f is coaxial with the fixing hole 212e. The adjusting section 212 includes a bolt member 212g, which is fixed to the adjusting section 212 by being received in the fixing hole 212e and the through hole 212f. The wheel 212d is rotatably sleeved on the bolt member 212g. The adjusting section 212 further includes a protruding pole 212h adjacent to the second end surface 212a.

Each clamping arm 21 defines a shaft hole 213 between the clamping portion 211 and the adjusting portion 212. Each clamping arm 21 is rotatably connected by a positioning member 22 to a corresponding positioning block 11. The positioning member 22 includes a shaft portion 222, and a cap portion 221 connected to an end of the shaft portion 222. The shaft portion 222 passes through the shaft hole 213 and is fixed in the positioning hole 111. A diameter of the cap portion 221 is larger than that of the shaft hole 213. Therefore, the cap portion 221 prevents the clamping arm 21 from falling off the shaft portion 222. The first inner side surfaces 211b of the clamping arms 21 are opposite to each other, and the recesses 211c of the clamping arms 21 cooperatively form a receiving space for receiving an optical lens therein. The adjusting sections 212 of the clamping arms 21 form an angle therebetween.

The clamping portion 20 further includes an elastic member 23 connected between the protruding poles 212h. The elastic member 23 helps maintain a predetermined distance between the clamp sections 211. In this embodiment, the elastic member 23 is a spring.

The engaging block 30 includes two opposite side surfaces 31. The side surfaces 31 taper at a predetermined angle toward an end of the engaging block 30. In this embodiment, the angle between the side surfaces 31 is substantially equal to that between the second inner side surfaces 212b of the clamping arms 21. The engaging block 30 includes two flanges 311 protruding from each side surface 31. The flanges 311 extend along the tapered side surfaces 31 and are substantially parallel to each other. A distance between the flanges 311 is slightly larger than an axial thickness of the wheel 212d. Therefore, the wheel 212d can roll along the side surfaces 31 between the flanges 311. The engaging block 30 is engaged between the adjusting sections 212 of the clamping arms 21. The side surfaces 31 contact with the peripheral surface of a corresponding wheel 212d, and the peripheral surface of the wheel 212d is sandwiched between the flanges 311. The engaging block 30 changes an angle between the adjusting sections 212 by a movement relative to the clamping portion 20. The engaging block 30 is fixed on a driving mechanism (not shown).

In use, an optical lens (not shown) is received in the receiving space formed by the recesses 211c. The engaging block 30 is pushed toward the clamping portion 20, and the side surfaces 31 of the engaging block 30 respectively press the wheels 212d to increase the angle between the adjusting sections 212 during the movement of the engaging block 30. The clamping arms 21 are rotated about the positioning members 22 by the engaging block 30, and a distance between the clamping sections 211 is accordingly decreased. Therefore, the optical lens is clamped between the clamping sections 211. A force applied on the optical lens by the clamping sections 211 is adjusted by changing a position of the engaging block 30 relative to the clamping portion 20. During rotation of the clamping arms 21, the elastic member 23 is elastically stretched by the protruding poles 212h.

To remove the optical lens from the clamping portion 20, the engaging block 30 is moved away from the clamping portion 20. During the movement of the engaging block 30, the adjusting sections 212 are pulled closer to each other by the restoring force of the elastic member 23, thereby moving the clamping sections 211 away from each other to release the optical lens.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. An optical lens clamping apparatus for clamping an optical lens, comprising:
a base;
a clamping portion positioned on the base, the clamping portion comprising two clamping arms rotatably connected to the base, each clamping portion comprising:
a clamping section; and
an adjusting section connected to the clamping section, the adjusting section and the clamping section form an obtuse angle therebetween, wherein the clamping sections of the clamping arms are positioned substantially parallel to each other and spaced from each other for a predetermined distance, the adjusting sections of the clamping arms form a predetermined angle therebetween; and
an engaging block movably engaged between the adjusting sections, the engaging block adjusting the angle between the adjusting sections to make the clamping sections clamp or release the optical lens by a movement relative to the clamping portion.

2. The optical lens clamping apparatus of claim 1, wherein the base comprises two positioning blocks corresponding to the clamping arms, the positioning blocks are spaced from each other, the clamping arms are rotatably connected to the positioning blocks, respectively.

3. The optical lens clamping apparatus of claim 1, wherein each clamping section comprises a first end surface facing away from the adjusting section and a first inner side surface facing toward the clamping section of the other clamping arm, the clamping section defines a recess in the first end surface for receiving the optical lens, the recess passes through the first inner surface.

4. The optical lens clamping apparatus of claim 1, wherein each adjusting section comprises a second end surface facing away from the clamping section and a second inner side surface facing toward the adjusting section of the other clamping arm.

5. The optical lens clamping apparatus of claim 4, wherein the adjusting section comprises a wheel rotatable adjacent to the second end surface, a portion of a round peripheral surface of the wheel protrudes out of the second inner side surface, the engaging block contact with the peripheral surface of the wheel.

6. The optical lens clamping apparatus of claim 5, wherein the adjusting section defines a groove in the second inner side surface, the wheel is rotatably received into groove.

7. The optical lens clamping apparatus of claim 5, wherein the engaging block comprises two opposite side surfaces, the engaging block tapers from an end to an opposite another end and the side surfaces form a predetermined angle therebetween, the side surfaces contact with the wheels, respectively.

8. The optical lens clamping apparatus of claim 7, wherein the engaging block comprises two flanges protruding from each side surface, the flanges extends from a larger end to a smaller end of the engaging block and are substantially parallel to each other, the peripheral surface of the wheel is sandwiched between the flanges.

9. The optical lens clamping apparatus of claim 5, wherein the adjusting section comprises a bolt member, the adjusting section defines a fixing hole passing through two opposite side of the adjusting section and communicating with the groove, the wheel defines a central through hole coaxial with the fixing hole, the bolt member passes through the fixing hole and the through hole and is fixed to the adjusting section.

10. The optical lens clamping apparatus of claim 5, wherein each adjusting section comprises a protruding pole adjacent to the second end surface, the clamping portion comprises an elastic member connected to the protruding pole.
